(19) United States
(12) Patent Application Publication
(10) Pub. No.: US 2006/0073056 A1
(43) Pub. Date: Apr. 6, 2006

(54) Hermetically sealed type orbiting vane compressor

(75) Inventors: Seon-woong Hwang, Anyang-Si (KR); Dong-won Yoo, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/111,851

(22) Filed: Apr. 22, 2005

(30) Foreign Application Priority Data
Oct. 6, 2004 (KR) 10-2004-0079608

(51) Int. Cl. F01C 1/063; F01C 20/18; F16N 13/20; F04C 2/00

(52) U.S. Cl. 418/59; 418/62; 418/30; 418/29

(57) ABSTRACT

Disclosed herein is a hermetically sealed type orbiting vane compressor constructed using an refrigerant gas compressing semi-hermetic vane compressor that comprises a hermetically sealed shell having an inlet tube and an outlet tube, a crankshaft having an oil supplying channel formed longitudinally therethrough, the crankshaft being rotated by a drive unit, a compression unit, having an orbiting vane connected to the crankshaft, for compressing and discharging refrigerant gas introduced into a cylinder according to an orbiting movement of the orbiting vane in an annular space defined in the cylinder, and an oil hole formed at a vane plate of the orbiting vane for allowing oil supplied through the crankshaft to be provided to the vane plate therethrough.

### BACKGROUND OF THE INVENTION

1. Field of the Invention

The present invention relates to an orbiting vane compressor, and, more particularly, to a hermetically sealed type orbiting vane compressor constructed using an air-compressing semi-hermetic vane compressor that compresses air introduced into a cylinder in two compression chambers formed in a cylinder according to an orbiting movement of a vane, the air-compressing semi-hermetic vane compressor being applicable as a hermetically sealed type refrigerant compressor used in a refrigerator or an air conditioner.

2. Description of the Related Art

Generally, a vane compressor compresses air introduced into a cylinder according to an orbiting movement of a vane. FIG. 1 is a longitudinal sectional view illustrating the structure of a conventional vane compressor.

As shown in FIG. 1, the vane compressor comprises a compression unit 100 connected to a drive unit (not shown) via a rotary shaft 120. The compression unit 100 is hermetically sealed by upper and lower housings 110 and 110a. In the compression unit 100 is disposed an orbiting vane 140, which is attached to an eccentric part 120a of the rotary shaft 120 for performing an orbiting movement in the upper part of a cylinder 130 when the rotary shaft 120 is rotated.

The cylinder 130 is provided at the upper part thereof with a cylinder cover 131 having inner and outer outlet holes 131a and 131b. In the cylinder 130 is disposed an inner ring 132. Between the inner ring 132 and the inner wall of the cylinder is defined an annular space 133. The orbiting vane 140 is provided at the upper part thereof with a circular vane 140a, which performs an orbiting movement in the annular space 133 of the cylinder 130. As a result, compression chambers are formed in the annular space 133 at the inside and the outside of the circular vane 140a.

The cylinder cover 131 is provided with an inlet hole 134 for allowing external air to be introduced into the cylinder 130. The inlet hole 134 is connected to an inlet tube 150, which vertically penetrates the upper housing 110. At a predetermined position of the circumferential part of the upper housing 110 is formed an outlet tube 160.

In the conventional vane compressor with the above-stated construction, external air is introduced into the cylinder 130 through the inlet tube 150 and the inlet hole 134. The air introduced into the cylinder 130 is compressed by the orbiting vane 140, which performs an orbiting movement in the cylinder 130 by power transmitted to the orbiting vane 140 from the drive unit via the rotary shaft 120. The compressed air is guided into the upper housing 110 through the inner and outer outlet holes 131a and 131b of the cylinder 130, and is then discharged out of the vane compressor through the outlet tube 160 of the upper housing 110.

It is impossible, however, to apply the conventional vane compressor with the above-stated construction and operation as a refrigerant compressor used in a refrigerator or an air conditioner.

More specifically, there is a negligible difference between the temperature of air before being compressed and the temperature of air after being compressed while there is a significant difference between the temperature of refrigerant gas before being compressed and the temperature of refrigerant gas after being compressed. Consequently, it is necessary to isolate a refrigerant gas inlet channel and a refrigerant gas outlet channel from each other, and to securely maintain refrigerant gas introduced into the cylinder in a low-temperature and low-pressure state.

In the conventional vane compressor, however, the inlet tube 150 extends through the inner space of the upper housing 110, into which compressed air is discharged. Consequently, when the conventional vane compressor is applied as a refrigerant compressor, low-temperature and low-pressure refrigerant gas introduced into the cylinder 130 through the inlet tube 150 is heated by high-temperature and high-pressure refrigerant gas, which has been compressed and discharged into the upper housing 110. As a result, the refrigerant gas is introduced into the cylinder in a high-temperature and low-pressure state, which decreases the volumetric efficiency of the compressor. Consequently, the compression performance of the compressor is deteriorated.

It can be seen from the above description that the refrigerant gas inlet channel and the refrigerant gas outlet channel must be isolated from each other without interference therebetween in order to ensure that the vane compressor performs the compression operation according to the orbiting movement of a vane as a refrigerant compressor.

When the inlet hole 134 is disposed above the circular vane 140a as described above, the sectional area of the refrigerant gas inlet channel, including the inlet tube 150 and the inlet hole 134, is limited to the radius of the compression chamber of the cylinder, i.e., the annular space 133 of the cylinder, which is relatively less than the height of the circular vane 140a. Consequently, it is impossible to increase the sectional area of the refrigerant gas inlet channel, which is necessary to reduce pressure loss.

When the inner and outer outlet holes 131a and 131b formed at the cylinder cover 131 are disposed adjacent to the outlet tube 160 of the upper housing 110, oil may be excessively discharged through the outlet tube 160.

Meanwhile, a scroll compressor, which is widely used in a refrigerator or an air conditioner, comprises a drive unit and a compression unit, which are connected to each other via a crankshaft in a hermetically sealed shell. In the scroll compressor, an orbiting scroll, which constitutes the above-discussed compression unit, performs an orbiting movement along an upper stationary scroll, when power is transmitted to the orbiting scroll from the drive unit through the crankshaft, for compressing refrigerant gas introduced into the compression unit.

The above-described scroll compressor has an advantage of performing high-efficiency compression. In the scroll compressor, however, wraps are integrally formed at the orbiting scroll and the stationary scroll in involute curves. Consequently, it is necessary to manufacture the wraps with high precision. As a result, the manufacturing costs of the scroll compressor are increased, and therefore, the price competitiveness of the compressor is lowered.

### SUMMARY OF THE INVENTION

Therefore, the present invention has been made in view of the above problems, and it is an object of the present invention to provide a hermetically sealed type orbiting vane compressor constructed using an air-compressing semi-hermetic vane compressor that compresses air introduced into a cylinder in two compression chambers formed in a cylinder according to an orbiting movement of a vane, the air-compressing semi-hermetic vane compressor being applicable as a hermetically sealed type refrigerant compressor used in a refrigerator or an air conditioner.

It is another object of the present invention to provide a hermetically sealed type orbiting vane compressor having a refrigerant gas inlet channel for introducing low-temperature and low-pressure refrigerant gas into the cylinder and a refrigerant gas outlet channel for discharging refrigerant gas, compressed according to an orbiting movement of the orbiting vane, out of the cylinder, the refrigerant gas inlet channel and the refrigerant gas outlet channel being isolated from each other while the sectional area of the refrigerant gas inlet channel is increased.

It is another object of the present invention to provide a hermetically sealed type orbiting vane compressor that is capable of accomplishing lubrication between a shaft, which is connected between a drive unit and a compression unit for transmitting power from the drive unit to the compression unit, and the orbiting vane.

It is another object of the present invention to provide a hermetically sealed type orbiting vane compressor that is capable of preventing the orbiting vane from leaning to one side due to overturning moment generated when the orbiting vane performs an orbiting movement in the cylinder by power transmitted from the drive unit to the compression unit through the shaft for compressing refrigerant gas introduced into the cylinder.

It is another object of the present invention to provide a hermetically sealed type orbiting vane compressor that is capable of supplying oil to the inside of the compression unit when lubrication is accomplished between the orbiting vane and the shaft.

It is yet another object of the present invention to provide a hermetically sealed type orbiting vane compressor having a slider disposed in an opening formed at the circular vane for maintaining the seal between high-pressure and low-pressure compression chambers formed in the cylinder when a circular vane provided at the upper part of the orbiting vane performs an orbiting movement in an annular space of the cylinder, the slider being easily and accurately manufactured with improved air-tightness.

In accordance with the present invention, the above and other objects can be accomplished by the provision of a hermetically sealed type orbiting vane compressor comprising: a hermetically sealed shell having an inlet tube and an outlet tube; a crankshaft having an oil supplying channel formed longitudinally therethrough, the crankshaft being rotated by a drive unit; a compression unit, having an orbiting vane connected to the crankshaft, for compressing and discharging refrigerant gas introduced into a cylinder according to an orbiting movement of the orbiting vane in an annular space defined in the cylinder; and an oil hole formed at a vane plate of the orbiting vane for allowing oil supplied through the crankshaft to be provided to the vane plate therethrough.

Preferably, the orbiting vane comprises: a circular vane formed at the upper part of the vane plate; and a boss formed at the lower part of the vane plate, the boss being connected to the crankshaft, and the oil hole is provided at the boss.

Preferably, the boss is formed at the upper part of the vane plate inside the circular vane while being protruded upward, the interior of the boss being opened at the lower part thereof such that the crankshaft is fitted in the interior of the boss.

Preferably, the circular vane is provided at a predetermined position of the circumferential part thereof with an opening, and the orbiting vane further comprises: a slider disposed in the opening.

Preferably, the circular vane is provided at another predetermined position of the circumferential part thereof, adjacent to the position where the slider is disposed, with a through-hole for allowing refrigerant gas to be introduced into the circular vane therethrough.

Preferably, the cylinder is provided at a predetermined position of the circumferential part thereof with an inlet port, which communicates with the through-hole of the circular vane.

Preferably, the slider has linear sliding contact surfaces formed at the inner and outer ends thereof, respectively, one of the linear sliding contact surfaces of the slider being parallel with the other linear sliding contact surface of the slider, and the cylinder is provided at the inner circumferential part thereof with a linear sliding guide surface, and an inner ring, which is disposed in the cylinder, is provided at the outer circumferential part thereof with another linear sliding guide surface, the linear sliding guide surface of the cylinder being parallel with the linear sliding guide surface of the inner ring, whereby the slider performs a linear reciprocating movement along the linear sliding guide surface of the cylinder and the linear sliding guide surface of the inner ring while the linear sliding contact surfaces of the slider are in contact with the linear sliding guide surface of the cylinder and the linear sliding guide surface of the inner ring, respectively.

Preferably, the annular space defined in the cylinder is divided into inner and outer compression chambers by a circular vane of the orbiting vane, which is inserted in the annular space.

Preferably, the annular space is defined between the inner wall of the cylinder and an inner ring disposed in the cylinder.

Preferably, the cylinder is provided at the upper part thereof with a pair of inner and outer outlet ports, which communicate with the inner and outer compression chambers, respectively.

Preferably, the compressor further comprises: a high and low pressure separating plate disposed between the outer circumference of the upper part of the cylinder and the inner circumferential part of the shell.

Preferably, the shell is constructed such that the inlet tube of the shell is disposed below the outlet tube of the shell, whereby the refrigerant gas is introduced through the inlet tube into the compression unit, is guided upward through a high-pressure chamber formed above the compression chamber, and is then discharged out of the compression unit though the outlet tube.

Preferably, the shell is constructed such that the inlet tube of the shell is disposed above the outlet tube of the shell, whereby the refrigerant gas is introduced through the inlet tube into the compression unit, is guided downward through the shell, and is then discharged out of the compression unit though the outlet tube.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a longitudinal sectional view illustrating the structure of a conventional vane compressor;

FIG. 2 is a longitudinal sectional view illustrating the overall structure of a hermetically sealed type orbiting vane compressor according to a first preferred embodiment of the present invention;

FIG. 3 is an enlarged sectional view illustrating “A” part of FIG. 2;

FIG. 4 is a cross-sectional view illustrating the operation of a compression unit of a hermetically sealed type orbiting vane compressor according to a preferred embodiment of the present invention;

FIG. 5 is a cross-sectional view illustrating the operation of a compression unit of a hermetically sealed type orbiting vane compressor according to another preferred embodiment of the present invention;

FIG. 6 is a longitudinal sectional view illustrating the overall structure of a hermetically sealed type orbiting vane compressor according to a second preferred embodiment of the present invention;

FIG. 7 is a longitudinal sectional view illustrating the overall structure of a hermetically sealed type orbiting vane compressor according to a third preferred embodiment of the present invention; and

FIG. 8 is an enlarged sectional view illustrating “B” part of FIG. 7.

### DESCRIPTION OF THE PREFERRED EMBODIMENTS

Now, preferred embodiments of the present invention will be described in detail with reference to the accompanying drawings.

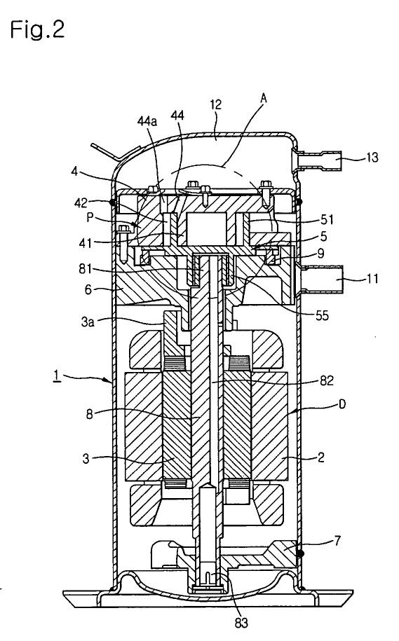

FIG. 2 is a longitudinal sectional view illustrating the overall structure of a hermetically sealed type orbiting vane compressor according to a first preferred embodiment of the present invention.

As shown in FIG. 2, a drive unit D and a compression unit P are mounted in a shell 1 while the drive unit D and the compression unit P are hermetically sealed. The drive unit D and the compression unit P are connected to each other via a vertical crankshaft 8, the upper and lower ends of which are rotatably supported by a main frame 6 and a subsidiary frame 7, such that power from the drive unit D is transmitted to the compression unit P through the crankshaft 8.

The drive unit D comprises: a stator 2 fixedly disposed between the main frame 6 and the subsidiary frame 7; and a rotor 3 disposed in the stator 2 for rotating the crankshaft 8, which vertically extends through the rotor 3, when electric current is supplied to the rotor 3. The rotor 3 is provided at the top and bottom parts thereof with balance weights 3a, which are disposed symmetrically to each other for preventing the crankshaft 8 from being rotated in an unbalanced state due to a crank pin 81.

The compression unit P comprises an orbiting vane 5 having a boss 55 formed at the lower part thereof. The crank pin 81 is fixedly fitted in the boss 55 of the orbiting vane 5. As the orbiting vane 5 performs an orbiting movement in a cylinder 4, refrigerant gas introduced into the cylinder 4 is compressed. The cylinder 4 comprises an inner ring 41 integrally formed at the upper part thereof while being protruded downward. The orbiting vane 5 comprises a circular vane 51 formed at the upper part thereof while being protruded upward. The circular vane 51 performs an orbiting movement in an annular space 42 defined between the inner ring 41 and the inner wall of the cylinder 4. Through the orbiting movement of the circular vane 51, inner and outer compression chambers are formed at the inside and the outside of the circular vane 51, respectively. Refrigerant gases compressed in the inner and outer compression chambers are discharged out of the cylinder 4 through inner and outer outlet ports 44 and 44a formed at the upper part of the cylinder 4, respectively.

Between the main frame 6 and the orbiting vane 5 is disposed an Oldham's ring 9 for preventing rotation of the orbiting vane 5. Through the crankshaft 8 is longitudinally formed an oil supplying channel 82 for allowing oil to be supplied to the compression unit P therethrough by a centrifugal force of the crankshaft 8. Preferably, an oil pump 83 is mounted at the lower end of the crankshaft 8 such that oil is more smoothly supplied to the compression unit P through the oil supplying channel 82 as the oil pump 83 is operated, as shown in FIG. 2.

The orbiting vane compressor according to the illustrated embodiment of the present invention is a low-pressure orbiting vane compressor wherein refrigerant gas compressed by the compression unit P is discharged to a high-pressure chamber 12 formed at the upper part of the shell 1 through the inner and outer outlet ports 44 and 44a of the cylinder 4. An outlet tube 13, which penetrates the shell 1, communicates with the high-pressure chamber 12. An inlet tube 11 is disposed below the outlet tube 13. Specifically, the inlet tube 11 penetrates the shell 1 such that the inlet tube 11 communicates with one side of the main frame 6.

When electric current is supplied to the drive unit D, the rotor 3 of the drive unit D is rotated, and therefore, the crankshaft 8 is also rotated. As the crankshaft 8 is rotated, the orbiting vane 5 of the compression unit P performs an orbiting movement along a radius of the orbiting movement while the crank pin 81 of the crankshaft 8 is fitted in the boss 55 formed at the lower part of the orbiting vane 5.

As a result, the circular vane 51 of the orbiting vane 5, which is inserted in the annular space 42 defined between the inner ring 41 and the inner wall of the cylinder 4, also performs an orbiting movement to compress refrigerant gas introduced into the annular space 42. At this time, the inner and outer compression chambers are formed at the inside and the outside of the circular vane 51 in the annular space 41, respectively. Refrigerant gases compressed in the inner and outer compression chambers are guided to the high-pressure chamber 12, which is formed at the upper part of the shell 1, through the inner and outer outlet ports 44 and 44a of the cylinder 4, which communicate with the inner and outer compression chambers, respectively, and are then discharged out of the orbiting vane compressor through the outlet tube 13. In this way, high-temperature and high-pressure refrigerant gas is discharged.

The cylinder 4 is provided at a predetermined position of the circumferential part thereof with an inlet port 43, through which refrigerant gas is introduced into the cylinder 4. If the inlet port 43 is formed at the upper part of the cylinder such that the inlet port 43 is connected in communication to an inlet tube, which vertically penetrates the shell 1, as in the conventional air-compressing vane compressor, the inlet tube extends through the high-pressure chamber 12, and therefore, heat exchange is performed between high-temperature and high-pressure refrigerant gas in the high-pressure chamber 12 and low-temperature and low-pressure refrigerant gas introduced into the cylinder through the inlet tube.

As heat exchange is performed between the low-temperature and low-pressure refrigerant gas introduced into the cylinder the high-temperature and high-pressure refrigerant gas in the high-pressure chamber as described above, the low-temperature and low-pressure refrigerant gas is changed into high-temperature and low-pressure refrigerant gas. When the high-temperature and low-pressure refrigerant gas is introduced into the cylinder 4 and compressed in the cylinder 4, however, compression efficiency of the orbiting vane compressor is considerably lowered. For this reason, the inlet port 43 is formed at a predetermined position of the circumferential part of the cylinder 4 in accordance with the present invention.

The upper and lower ends of the crankshaft 8 are supported by the main frame 6 and the subsidiary frame 7. Consequently, when the refrigerant gas is compressed in the cylinder 4 according to the orbiting movement of the orbiting vane 5, the crankshaft 8 is more stably supported while the crankshaft 8 is rotated. Furthermore, abnormal noise, for example, electronic noise, is prevented from being generated due to air gap.

Generally, the rotor 3 disposed inside the stator 2 is rotated concentrically to the crankshaft 8 when the drive unit D is operated. When the rotor 3 is rotated eccentrically to the crankshaft 8, however, air gap is formed between the rotor 3 and the crankshaft 8, by which abnormal noise, for example, electronic noise, is generated. In the case that the upper and lower ends of the crankshaft 8 are stably supported by the main frame 6 and the subsidiary frame 7 in accordance with the present invention, it is ensured that the rotor 3 is rotated concentrically to the crankshaft 8. Consequently, air gap is not formed between the rotor 3 and the crankshaft 8, and therefore, the abnormal noise is not generated.

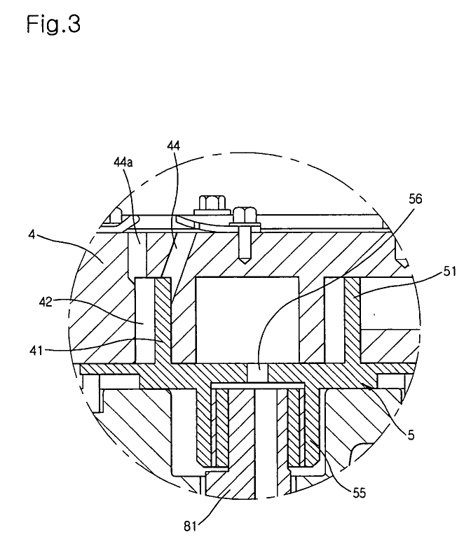

Also, the oil supplying channel 82 is longitudinally formed through the crankshaft 8, and the oil pump 83 is mounted at the lower end of the crankshaft 8. Consequently, when the oil pump 83 is operated, oil gathered in the lower part of the shell 1 is forcibly supplied to the space between the boss 55 of the orbiting vane 5 and the crank pin 81 of the crankshaft 8 through the oil supplying channel 82 of the crankshaft 8 for accomplishing lubrication between the boss 55 of the orbiting vane 5 and the crank pin 81 of the crankshaft 8. In the case that an oil hole 56 is formed through the orbiting vane 5 inside the boss 55, as shown in FIG. 3, lubrication is also accomplished between the inner ring 41 of the cylinder 4 and the circular vane 51 of the orbiting vane 5, which together constitute the compression unit P.

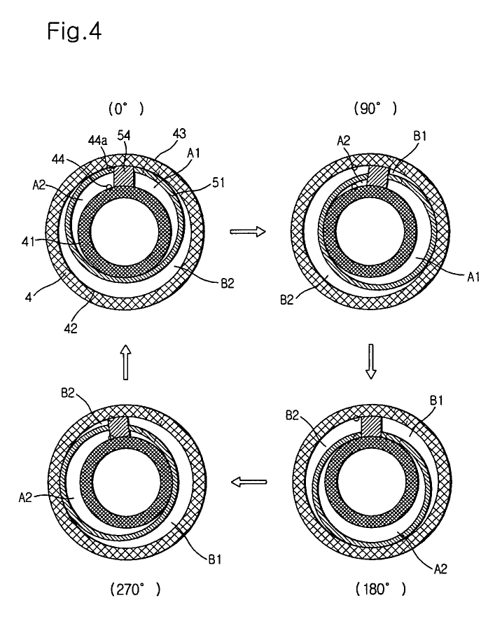

FIG. 4 is a cross-sectional view illustrating the operation of a compression unit of a hermetically sealed type orbiting vane compressor according to a preferred embodiment of the present invention.

When the orbiting vane 5 of the compression unit P is driven by power transmitted to the compression unit P from the drive unit D through the crankshaft 8 (See FIG. 2), the circular vane 51 of the orbiting vane 5 disposed in the annular space 42 of the cylinder 4 performs an orbiting movement in the annular space 42 defined between the inner wall of the cylinder 4 and the inner ring 41, as indicated by arrows, to compress refrigerant gas introduced into the annular space 42 through the inlet port 43.

At the initial orbiting position of the orbiting vane 5 of the compression unit P (i.e., the 0-degree orbiting position), refrigerant gas is introduced into an inner suction chamber Al through the inlet port 43 and the through-hole 52 of the circular vane 51, and compression is performed in an outer compression chamber B2 of the circular vane 51 while the outer compression chamber B2 does not communicate with the inlet port 43 and the outer outlet port 44a. Refrigerant gas is compressed in an inner compression chamber A2, and at the same time, the compressed refrigerant gas is discharged out of the inner compression chamber A2 through the inner outlet port 44.

At the 90-degree orbiting position of the orbiting vane 5 of the compression unit P, the compression is still performed in the outer compression chamber B2 of the circular vane 51, and almost all the compressed refrigerant gas is discharged out of the inner compression chamber A2 through the inner outlet port 44. At this stage, an outer suction chamber B1 appears so that refrigerant gas is introduced into the outer suction chamber B1 through the inlet port 43.

At the 180-degree orbiting position of the orbiting vane 5 of the compression unit P, the inner suction chamber A1 disappears. Specifically, the inner suction chamber A1 is changed into the inner compression chamber A2, and therefore, compression is performed in the inner compression chamber A2. At this stage, the outer compression chamber B2 communicates with the outer outlet port 44a. Consequently, compressed refrigerant gas is discharged out of the outer compression chamber B2 through the outer outlet port 44a.

At the 270-degree orbiting position of the orbiting vane 5 of the compression unit P, almost all the compressed refrigerant gas is discharged out of the outer compression chamber B2 of the circular vane 51 through the outer outlet port 44a, and the compression is still performed in the inner compression chamber A2 of the circular vane 51. Also, compression is newly performed in the outer suction chamber B1. When the orbiting vane 5 of the compression unit P further performs the orbiting movement by 90 degrees, the outer suction chamber B1 disappears. Specifically, the outer suction chamber B1 is changed into the outer compression chamber B2, and therefore, the compression is continuously performed in the outer compression chamber B2. As a result, the orbiting vane 5 of the compression unit P is returned to the position where the orbiting movement of the orbiting vane 5 is initiated. In this way, a 360-degree-per-cycle orbiting movement of the orbiting vane 5 of the compression unit P is accomplished. The orbiting movement of the orbiting vane 5 of the compression unit P is repeatedly performed in succession.

The slider 54, which is slidably disposed in the opening 53 of the circular vane 51, maintains the seal between compression chambers A2 and B2 and suction chambers A1 and B1, which are formed when the circular vane 51 performs an orbiting movement in the annular space 42 of the cylinder 4, i.e., between high-pressure sides and low-pressure sides, respectively. Specifically, the slider 54 performs a reciprocating slide movement along the curved inner wall of the cylinder during the orbiting movement of the circular vane 51. Consequently, it is necessary to manufacture the slider 54 with high precision such that air-tight contact is accomplished not only between the inner wall of the cylinder 4 and the slider 54 but also between the inner ring 41 and the slider 54.

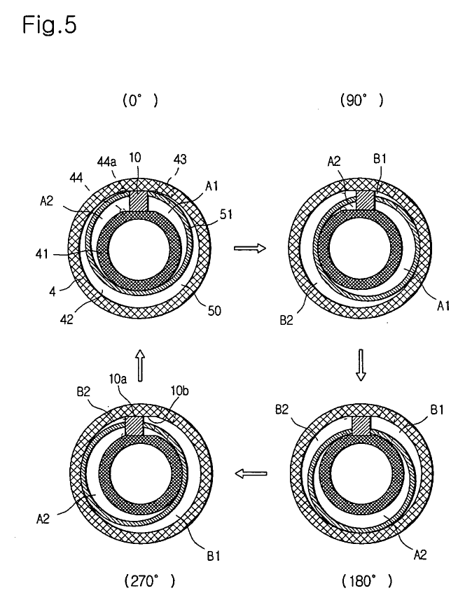

FIG. 5 is a cross-sectional view illustrating the operation of a compression unit of a hermetically sealed type orbiting vane compressor according to another preferred embodiment of the present invention.

The compression unit according this embodiment does not require that the slider 54 be manufactured with high precision unlike the previously described embodiment of the present invention. Specifically, the compression unit according to this embodiment is characterized by a linear slider 10 that performs a linear reciprocating movement during the orbiting movement of the circular vane 51.

The linear slider 10 has a pair of linear sliding contact surfaces 10a, which are formed at the inner and outer ends thereof, respectively. Correspondingly, the cylinder 4 is provided at inner circumferential part with a linear sliding guide surface 10b having a predetermined length, and the inner ring 41 is provided at the outer circumferential part thereof with another linear sliding guide surface 10b having the same length as the linear sliding guide surface 10b of the cylinder 4. The linear sliding contact surfaces 10a of the linear slider 10 are parallel with each other. Similarly, the linear sliding guide surface 10b of the cylinder 4 is parallel with the linear sliding guide surface 10b of the inner ring 41.

When the circular vane 51 performs an orbiting movement in the cylinder 4, the linear slider performs a linear reciprocating movement along the linear sliding guide surface 10b of the cylinder 4 and the linear sliding guide surface 10b of the inner ring 41 while the linear sliding contact surfaces 10a of the linear slider 10 are in contact with the linear sliding guide surface 10b of the cylinder 4 and the linear sliding guide surface 10b of the inner ring 41, respectively.

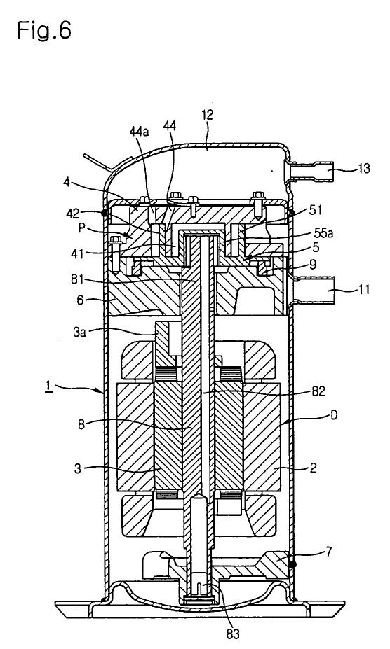

FIG. 6 is a longitudinal sectional view illustrating the overall structure of a hermetically sealed type orbiting vane compressor according to a second preferred embodiment of the present invention.

The hermetically sealed type orbiting vane compressor according to the second preferred embodiment of the present invention is a low-pressure orbiting vane compressor like the orbiting vane compressor according to the previously described fist preferred embodiment of the present invention, and the hermetically sealed type orbiting vane compressor according to the second preferred embodiment of the present invention is identical in construction and operation to the orbiting vane compressor according to the previously described first embodiment of the present invention except that the orbiting vane 5 is structurally modified.

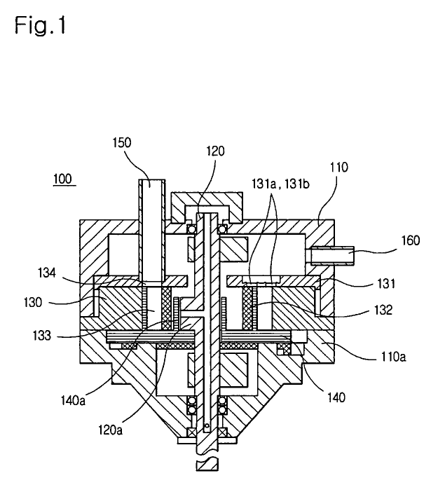

More specifically, the orbiting vane 5 comprises the boss 55, in which the crank pin 81 of the crankshaft 8 is fitted, and the circular vane 51 disposed in the annular space 42 of the cylinder 4 for performing an orbiting movement to suction and compress refrigerant gas. In the orbiting vane 5 according to the first preferred embodiment of the present invention, the boss 55 is formed at the lower surface of a vane plate 50 of the orbiting vane 5 (See FIG. 1). On the other hand, the orbiting vane 5 according to the second preferred embodiment of the present invention comprises a top boss 55a, which is formed at the upper surface of the vane plate 50 of the orbiting vane 5 while being protruded upward.

The orbiting vane 5 according to this illustrated embodiment of the present invention has an advantage of preventing the orbiting vane 5 from leaning to one side due to overturning moment generated when the orbiting vane 5 performs an orbiting movement in the cylinder 4 to compress refrigerant gas introduced into the cylinder 4 by the provision of the top boss 55a. If the orbiting vane 5 leans to one side, leakage occurs between the inner ring 41 of the cylinder 4 and the circular vane 51 of the orbiting vane 5, and therefore, the compression efficiency of the orbiting vane compressor is lowered. Consequently, it is preferable to use the orbiting vane 5 with the top boss 55a disposed at the upper part of the orbiting vane 5.

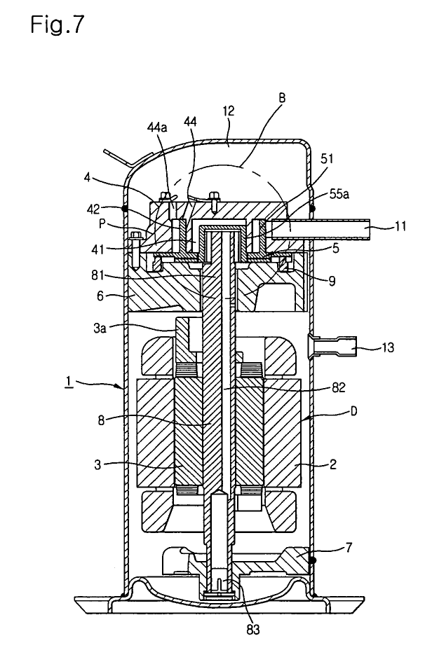

FIG. 7 is a longitudinal sectional view illustrating the overall structure of a hermetically sealed type orbiting vane compressor according to a third preferred embodiment of the present invention.

The hermetically sealed type orbiting vane compressor according to the third preferred embodiment of the present invention is characterized by a high-pressure orbiting vane compressor. The hermetically sealed type orbiting vane compressor according to the third preferred embodiment of the present invention is identical in construction and operation to the orbiting vane compressor except that the inlet tube 11 penetrates the shell 1 to communicate with the inlet port 43 formed at the circumferential part of the cylinder 4, and the outlet tube 13 is disposed below the inlet tube 11 while the outlet tube 13 also penetrates the shell 1.

In the hermetically sealed type orbiting vane compressor according to the third preferred embodiment of the present invention, refrigerant gas is introduced into the cylinder 4 through the inlet tube 11 and the inlet port 43. The refrigerant gas introduced into the cylinder 4 is compressed by the orbiting vane 5 that performs an orbiting movement by power transmitted to the orbiting vane 5 from the drive unit D through the crankshaft 8, and is then guided into the shell 1 through the inner and outer outlet ports 44 and 44a of the cylinder 4. The compressed refrigerant gas, having high temperature and high pressure, in the shell 1 is discharged out of the shell 1 through the outlet tube 13. Other technical construction of the hermetically sealed type orbiting vane compressor according to the third preferred embodiment of the present invention is identical to that of the hermetically sealed type orbiting vane compressor according to the second preferred embodiment of the present invention. Accordingly, a further detailed description of the hermetically sealed type orbiting vane compressor according to the third preferred embodiment of the present invention will not be given.

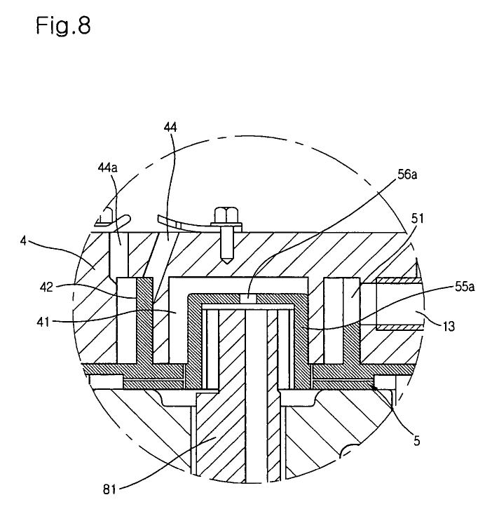

FIG. 8 is an enlarged sectional view illustrating “B” part of FIG. 7.

As shown in FIG. 8, the oil hole 56 is formed through the center part of the top boss 55a. Consequently, when oil is supplied to the space between the top boss 55 of the orbiting vane 5 and the crank pin 81 of the crankshaft 8 through the oil supplying channel 82 of the crankshaft 8, the oil is also supplied to the space between the inner ring 41 of the cylinder 4 and the circular vane 51 of the orbiting vane 5, which together constitute the compression unit P, through the oil hole 56a.

As apparent from the above description, the compression unit, which comprises the orbiting vane and the cylinder, and the drive unit for rotating the crankshaft, which is connected to the compression unit, when electric current is supplied to the drive unit, are hermetically disposed in the shell of the orbiting vane compressor, and refrigerant gas introduced into the cylinder is compressed through an orbiting movement of the orbiting vane. As a result, the hermetically sealed type orbiting vane compressor according to the present invention can be used as a hermetically sealed type refrigerant compressor used in a refrigerator or an air conditioner. Also, it is not necessary to manufacture the wraps with high precision unlike the conventional scroll compressor. Consequently, the present invention has the effect of reducing the manufacturing costs of the hermetically sealed type orbiting vane compressor, and therefore, increasing the price competitiveness of the compressor.

Also, the orbiting vane compressor according to the present invention is constructed such that external refrigerant gas can be introduced into the cylinder through the circumferential part of the cylinder. As a result, isolation is possible between the refrigerant gas inlet channel and the refrigerant gas outlet channel, and therefore, low-temperature and low-pressure refrigerant gas introduced into the cylinder through the refrigerant gas inlet channel is prevented from being heated by high-temperature and high-pressure refrigerant gas discharged out of the cylinder through the refrigerant gas outlet channel. Consequently, the present invention has the effect of improving compression efficiency of the compressor, and therefore, improving performance and reliability of the compressor.

Also, the oil supplying channel is formed through the crankshaft, which is disposed between the drive unit and the compression unit for transmitting power from the drive unit to the compression unit, such that oil is supplied into the space between the crank pin of the crankshaft and the boss of the orbiting vane to accomplish lubrication between the crank pin of the crankshaft and the boss of the orbiting vane, and thus, to prevent the crank pin of the crankshaft and the boss of the orbiting vane from being worn due to friction therebetween. Consequently, the present invention has the effect of preventing decrease of the service life of the compressor while accomplishing smooth operability.

Also, the orbiting vane compressor according to the present invention is constructed such that external refrigerant gas can be introduced into the cylinder through the circumferential part of the cylinder. Consequently, the present invention has the effect of increasing the sectional area of the refrigerant gas inlet channel, which is limited to the radius of the compression chamber of the cylinder, i.e., the annular space of the cylinder, in the conventional orbiting vane compressor.

Also, the top boss of the orbiting vane, by which the orbiting vane and the crankshaft are connected to each other, is formed at the upper surface of the vane plate of the orbiting vane while being protruded upward. Consequently, the present invention has the effect of preventing the orbiting vane from leaning to one side due to overturning moment generated when the orbiting vane performs an orbiting movement in the cylinder to compress refrigerant gas introduced into the cylinder, and therefore, improving performance and accurate operability of the compressor.

According to the present invention, oil is also supplied into the compression unit to accomplish lubrication in the compression unit while lubrication is accomplished between the orbiting vane and the crankshaft by the oil supplied through the crankshaft. Consequently, the present invention has the effect of improving performance and reliability of the compressor.

Furthermore, the slider, which performs a sliding movement along with the orbiting vane during the orbiting movement of the orbiting vane, is constructed in the form of a linear slider, which performs a linear reciprocating movement. Consequently, the present invention has the effect of improving the seal between the high-pressure and low-pressure sides with the linear slider being easily manufactured.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An orbiting vane comprising:
a circular vane formed at the upper part of a vane plate; and
a boss formed at the lower part of the vane plate, the boss being provided with an oil hole.

2. The vane as set forth in claim 1, wherein the boss is formed at the vane plate inside the circular vane while being protruded outward.

3. The vane as set forth in claim 1, wherein
the circular vane is provided at a predetermined position of the circumferential part thereof with an opening, and
the orbiting vane further comprises: a slider disposed in the opening.

4. The vane as set forth in claim 3, wherein the circular vane is provided at another predetermined position of the circumferential part thereof, adjacent to the position where the slider is disposed, with a through-hole for allowing refrigerant gas to be introduced into the circular vane therethrough.

5. A compression unit of an orbiting vane compressor, comprising:
a crankshaft having an oil supplying channel formed longitudinally therethrough;
an orbiting vane connected to the crankshaft for performing an orbiting movement in an annular space defined in a cylinder; and
an oil hole formed at a vane plate of the orbiting vane for allowing oil supplied through the crankshaft to be provided to the vane plate therethrough.

6. The unit as set forth in claim 5, wherein the orbiting vane comprises:
a circular vane formed at the upper part of the vane plate; and
a boss formed at the lower part of the vane plate, the boss being connected to the crankshaft, and wherein
the oil hole is provided at the boss.

7. The unit as set forth in claim 6, wherein the boss is formed at the vane plate inside the circular vane while being protruded outward.

8. The unit as set forth in claim 6, wherein
the circular vane is provided at a predetermined position of the circumferential part thereof with an opening, and
the orbiting vane further comprises: a slider disposed in the opening.

9. The unit as set forth in claim 8, wherein the circular vane is provided at another predetermined position of the circumferential part thereof, adjacent to the position where the slider is disposed, with a through-hole for allowing refrigerant gas to be introduced into the circular vane therethrough.

10. The unit as set forth in claim 9, wherein the cylinder is provided at a predetermined position of the circumferential part thereof with an inlet port, which communicates with the through-hole of the circular vane.

11. The unit as set forth in claim 5, wherein the annular space defined in the cylinder is divided into inner and outer compression chambers by a circular vane of the orbiting vane, which is inserted in the annular space.

12. The unit as set forth in claim 11, wherein the annular space is defined between the inner wall of the cylinder and an inner ring disposed in the cylinder.

13. The unit as set forth in claim 11, wherein the cylinder is provided at the upper part thereof with a pair of inner and outer outlet ports, which communicate with the inner and outer compression chambers, respectively.

14. A hermetically sealed type orbiting vane compressor comprising:
a hermetically sealed shell having an inlet tube and an outlet tube;
a crankshaft having an oil supplying channel formed longitudinally therethrough, the crankshaft being rotated by a drive unit;
a compression unit, having an orbiting vane connected to the crankshaft, for compressing and discharging refrigerant gas introduced into a cylinder according to an orbiting movement of the orbiting vane in an annular space defined in the cylinder; and
an oil hole formed at a vane plate of the orbiting vane for allowing oil supplied through the crankshaft to be provided to the vane plate therethrough.

15. The compressor as set forth in claim 14, wherein the orbiting vane comprises:
a circular vane formed at the upper part of the vane plate; and
a boss formed at the lower part of the vane plate, the boss being connected to the crankshaft, and wherein
the oil hole is provided at the boss.

16. The compressor as set forth in claim 15, wherein the boss is formed at the upper part of the vane plate inside the circular vane while being protruded upward, the interior of the boss being opened at the lower part thereof such that the crankshaft is fitted in the interior of the boss.

17. The compressor as set forth in claim 15, wherein
the circular vane is provided at a predetermined position of the circumferential part thereof with an opening, and
the orbiting vane further comprises: a slider disposed in the opening.

18. The compressor as set forth in claim 17, wherein the circular vane is provided at another predetermined position of the circumferential part thereof, adjacent to the position where the slider is disposed, with a through-hole for allowing refrigerant gas to be introduced into the circular vane therethrough.

19. The compressor as set forth in claim 18, wherein the cylinder is provided at a predetermined position of the circumferential part thereof with an inlet port, which communicates with the through-hole of the circular vane.

20. The compressor as set forth in claim 17, wherein
the slider has linear sliding contact surfaces formed at the inner and outer ends thereof, respectively, one of the linear sliding contact surfaces of the slider being parallel with the other linear sliding contact surface of the slider, and
the cylinder is provided at the inner circumferential part thereof with a linear sliding guide surface, and an inner ring, which is disposed in the cylinder, is provided at the outer circumferential part thereof with another linear sliding guide surface, the linear sliding guide surface of the cylinder being parallel with the linear sliding guide surface of the inner ring,
whereby the slider performs a linear reciprocating movement along the linear sliding guide surface of the cylinder and the linear sliding guide surface of the inner ring while the linear sliding contact surfaces of the slider are in contact with the linear sliding guide surface of the cylinder and the linear sliding guide surface of the inner ring, respectively.

21. The compressor as set forth in claim 14, wherein the annular space defined in the cylinder is divided into inner and outer compression chambers by a circular vane of the orbiting vane, which is inserted in the annular space.

22. The compressor as set forth in claim 21, wherein the annular space is defined between the inner wall of the cylinder and an inner ring disposed in the cylinder.

23. The compressor as set forth in claim 21, wherein the cylinder is provided at the upper part thereof with a pair of inner and outer outlet ports, which communicate with the inner and outer compression chambers, respectively.

24. The compressor as set forth in claim 14, further comprising:
a high and low pressure separating plate disposed between the outer circumference of the upper part of the cylinder and the inner circumferential part of the shell.

25. The compressor as set forth in claim 24, wherein the shell is constructed such that the inlet tube of the shell is disposed below the outlet tube of the shell, whereby the refrigerant gas is introduced through the inlet tube into the compression unit, is guided upward through a high-pressure chamber formed above the compression chamber, and is then discharged out of the compression unit though the outlet tube.

26. The compressor as set forth in claim 24, wherein the shell is constructed such that the inlet tube of the shell is disposed above the outlet tube of the shell, whereby the refrigerant gas is introduced through the inlet tube into the compression unit, is guided downward through the shell, and is then discharged out of the compression unit though the outlet tube.
